(19) United States
(12) Patent Application Publication
(10) Pub. No.: US 2025/0206863 A1
(43) Pub. Date: Jun. 26, 2025

(54) COPOLYMER AND CONTACT LENS TREATMENT SOLUTION

(71) Applicant: Nof Corporation, Tokyo (JP)

(72) Inventors: Norio IWAKIRI, Kanagawa (JP); Hiroko KAWASAKI, Kanagawa (JP); Yoshiki TANAKA, Kanagawa (JP); Ryuya GOTANDA, Kanagawa (JP)

(73) Assignee: Nof Corporation, Tokyo (JP)

(21) Appl. No.: 18/850,611

(22) PCT Filed: Mar. 27, 2023
(86) PCT No.: PCT/JP2023/012251

§ 371 Date: Sep. 25, 2024

(30) Foreign Application Priority Data
Mar. 30, 2022 (JP) 2022056393

(51) Int. Cl. C08F 220/36; C08F 220/30; G02C 7/04

(52) U.S. Cl. CPC C08F 220/36; C08F 220/303; G02C 7/04

(57) ABSTRACT

Provided is a copolymer that imparts hydrophilicity and antifouling properties to a contact lens by a simple method and maintains lasting effects thereof. A copolymer (P) comprises constituent units represented by formula (1a) and formula (1b), the molar ratio nₐ:n_{b} of the constituent units being 10-99: 1-90, and the weight average molecular weight being 10,000-2,000,000. (In formula (1a), R¹ is a hydrogen atom or a methyl group, and W¹ is O or NR², where R² is H or a C1-4 alkyl group.) (In formula (1b), R¹ is a hydrogen atom or a methyl group, R² is H or a C1-4 alkyl group, L¹ is a C1-5 alkylene group, or a C1-5 alkylene group including one or more hydroxy groups, and m is an integer of 2 or 3.)

### TECHNICAL FIELD

The present invention relates to a copolymer that imparts hydrophilicity, stain resistance, and sustained effects thereof to contact lenses, as well as a contact lens treatment solution containing the copolymer.

### BACKGROUND ART

Contact lenses have been used for vision improvement since the 1950s. The first contact lenses were hard contact lenses. Although these lenses are still in use, they are not widely used because they are inferior in initial comfort. In the 1960s, soft contact lenses made of hydrogel were developed. Due to their ease of use and convenience, the number of wearers rapidly increased, and these lenses have now become widely used medical devices. However, there is a possibility that the health of the wearer's eye may be adversely affected by the deposition of proteins or lipids on the lens during wear. This deposition decreases the wettability of the soft contact lens surface and causes discomfort. Research on improving the comfort of wearing contact lenses is still insufficient, and there is a demand for methods to enhance the surface hydrophilicity of contact lenses and to impart stain resistance.

To address the aforementioned issues, methods for performing surface treatments on contact lenses have been developed. For example, a method has been disclosed in which a hydrophilic monomer is graft-polymerized onto the surface of a contact lens having been subjected to plasma treatment to impart hydrophilicity and stain resistance to the surface (Patent Literature (hereinafter, referred to as PTL) 1). Additionally, a method for producing a contact lens with improved hydrophilicity and lubricity by coating a polymer on the surface of the contact lens has been disclosed (PTL 2). However, these surface treatments involve complicated steps, making them undesirable for mass production.

### CITATION LIST

### Patent Literature

PTL 1
Japanese Patent Application Laid-Open No. 2003-215509
PTL 2
Japanese Patent Application Laid-Open No. 2018-022174

### SUMMARY OF INVENTION

### Technical Problem

An object of the present invention is to provide a copolymer and a contact lens treatment solution including the copolymer, each capable of imparting hydrophilicity and stain resistance to contact lenses through a simple method, and these effects are sustained over time.

### Solution to Problem

The present inventors, through diligent research, have discovered that a novel copolymer composed of a monomer containing a functional group with two or three hydroxy groups on a benzene ring and a monomer containing a phosphorylcholine group can solve the aforementioned problems, leading to the completion of the present invention.

That is, an embodiment of the present invention for solving the problems described above relates to a copolymer (P) including constituent units represented by formulas (1a) and (1b), in which a molar ratio nₐ:n_{b} between the constituent units is 10 to 99:1 to 90, and the copolymer (P) has a weight average molecular weight of 10,000 to 2,000,000.

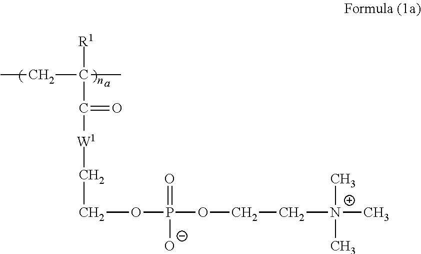

(In formula (1a), R¹ is a hydrogen atom or a methyl group, and W¹ is O or NR², where R² is H or an alkyl group having 1 to 4 carbon atoms.)

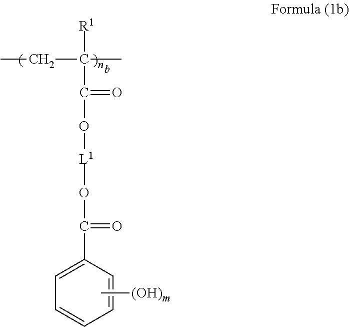

(In formula (1b), R¹ is a hydrogen atom or a methyl group, L¹ is an alkylene group having 1 to 5 carbon atoms or an alkylene group having 1 to 5 carbon atoms and including one or more hydroxy groups, and m is an integer of 2 or 3.)

Another aspect of the present invention for solving the problems described above relates to a contact lens treatment solution including 0.001 to 5.0 w/v % of the copolymer (P).

### Advantageous Effects of Invention

The copolymer of the present invention includes the following: a monomer that has a functional group with two or three hydroxy groups on a benzene ring; and a phosphorylcholine-based monomer. The copolymer of the present invention can impart sustained hydrophilicity and stain resistance to the surface of a contact lens. The copolymer of the present invention is useful as a contact lens treatment agent and is particularly suitable for a contact lens shipping liquid.

### DESCRIPTION OF EMBODIMENTS

Hereinafter, the present invention will be described in more detail.

In the present specification, when a preferable numerical range (for example, a range of concentration or weight average molecular weight) is described stepwise, each lower limit and upper limit can be combined independently. For example, in the description “the value is preferably 10 or more and more preferably 20 or more, and preferably 100 or less and more preferably 90 or less,” the “preferred lower limit 10” and “the more preferred upper limit 90” can be combined to form a range “10 or more and 90 or less”. For example, also from the description of “preferably 10 to 100, more preferably 20 to 90”, a range “10 to 90” can similarly be formed.

In the present invention, “(meth)acryl” means acryl or methacryl, “(meth)acryloyl” means acryloyl or methacryloyl, “(meth)acrylate” means acrylate or methacrylate, and “(meth)acrylamide” means acrylamide or methacrylamide.

Specific product embodiments of the contact lens treatment solution of the present invention may specifically include the following: a contact lens shipping liquid (contact lens packaging liquid), a contact lens storage liquid, a contact lens washing liquid, a contact lens washing and storage liquid, a contact lens disinfectant, eye drops, a contact lens insertion solution, and the like. Among these, it is particularly preferable to use for the contact lens shipping liquid.

In the present specification, the contact lens shipping liquid refers to a solution that is sealed in a packaging container, such as a blister package, together with a contact lens when the contact lens is distributed. In general, contact lenses are used in a state of being swollen with an aqueous solution. Therefore, at the time of shipment, the lenses are enclosed in a packaging container in this swollen state so that they can be used immediately.

In the present specification, hydrophilicity refers to the effect of increasing the water film retention on the surface of a contact lens and/or the effect of decreasing the contact angle in the droplet method (increasing in the case of the bubble method).

The term “stain resistance” refers to the effect of reducing the amount of substances that adhere to contact lenses, such as proteins, antibacterial agents, and hydrophobic substances such as lipids.

### [Copolymer (P)]

The copolymer (P) of the present invention is obtained by polymerizing a phosphorylcholine group-containing monomer (with molar number nₐ) represented by general formula (1a-1) below and a phenolic hydroxy group-containing monomer (with molar number n_{b}) represented by general formula (1b-1) below. The molar ratio nₐ:n_{b} between the constituent units is 10 to 99:1 to 90, and the weight average molecular weight of each constituent unit is 10,000 to 2,000,000.

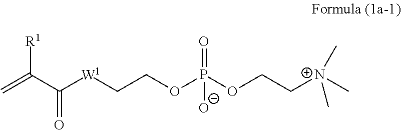

In formula (1a-1), R¹ is a hydrogen atom or a methyl group, and W¹ is O or NR², where R² is H or an alkyl group having 1 to 4 carbon atoms (for example, a methyl group, an ethyl group, or a propyl group).

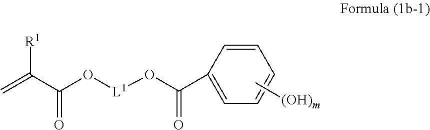

In formula (1b-1), R¹ is a hydrogen atom or a methyl group, L¹ is an alkylene group having 1 to 5 carbon atoms, or L¹ is an alkylene group having 1 to 5 carbon atoms and including one or more hydroxy groups, and m is an integer of 2 or 3.

[Monomer Represented by Formula (1a-1)]

The copolymer (P) used in the present invention has a constituent unit represented by general formula (1a). The constituent unit is obtained by using, in the polymerization, a hydrophilic monomer represented by general formula (1a-1), namely, a monomer having a phosphorylcholine structure (hereinafter also referred to as the “hydrophilic monomer” or the “PC monomer”). By having a PC monomer as a constituent unit, the copolymer (P) can exhibit stain resistance.

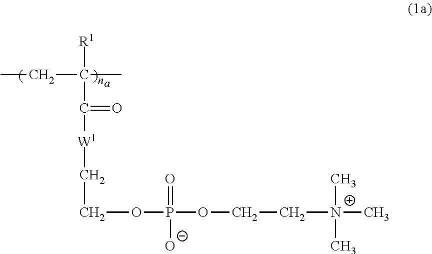

R¹ is a hydrogen atom or a methyl group, and W¹ is O or NR², where R² is H or an alkyl group having 1 to 4 carbon atoms (for example, a methyl group, an ethyl group, or a propyl group).

In the case of W¹ being an oxygen atom, R¹ is preferably a methyl group from the viewpoint of polymerizability and stability. In the case of W¹ being NR², R¹ is preferably a hydrogen atom from the viewpoint of polymerizability.

Examples of the monomer represented by formula (1a-1) preferably include 2-(meth)acryloyloxyethyl (2-(trimethylammonio)ethyl) phosphate in which W¹ is an oxygen atom, 2-(meth)acrylamidoethyl (2-(trimethylammonio)ethyl) phosphate in which W¹ is NR² and R² is H, more preferably include 2-methacryloyloxyethyl (2-(trimethylammonio)ethyl) phosphate in which R¹ is a methyl group and W¹ is 0, and 2-acrylamidoethyl (2-(trimethylammonio)ethyl) phosphate in which R¹ is a hydrogen atom, W¹ is NR², and R² is H. A still more preferable example is, from the viewpoint of availability, 2-methacryloyloxyethyl (2-(trimethylammonio)ethyl) phosphate.

[Monomer Represented by Formula (1b-1)]

The copolymer (P) used in the present invention has a constituent unit represented by general formula (1b). The constituent unit is obtained by using, in the polymerization, a monomer represented by formula (1b-1), preferably a monomer having a catechol group or a galloyl group. By having the constituent unit represented by formula (1b), the copolymer (P) can exhibit adsorbability to and sustainability in a contact lens.

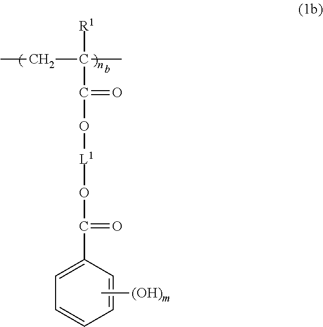

R¹ is a hydrogen atom or a methyl group, and L¹ is an alkylene group having 1 to 5 carbon atoms or an alkylene group having 1 to 5 carbon atoms and including one or more hydroxy groups, and m is an integer of 2 or 3.

L¹ is preferably an alkylene group having 2 to 4 carbon atoms or an alkylene group having 2 to 4 carbon atoms and including one or more hydroxy groups, more preferably an alkylene group having 3 carbon atoms or an alkylene group having 3 carbon atoms and including one or more hydroxy groups. From the viewpoint of easy synthesis, an alkylene group having 2 to 4 carbon atoms and including one hydroxy group is preferred, and an alkylene group having 3 carbon atoms and including one hydroxy group is more preferred.

From the viewpoint of availability, m is preferably 3.

An suitable example of formula (1b-1) is formula (1b-2) where L¹ is an alkylene group having 3 carbon atoms and including one hydroxy group. Formula (1b-3) where R¹ is a methyl group, L¹ is an alkylene group having 3 carbon atoms and including one hydroxy group, and m is 2 (catechol group) is preferred. Additionally, formula (1b-4) where R¹ is a methyl group, L¹ is an alkylene group having 3 carbon atoms and including one hydroxy group, and m is 3 (galloyl group) is more preferred. From the viewpoint of availability, formula (1b-4) where m is 3 (galloyl group) is more preferred.

The monomer represented by formulas (1b-4) can be synthesized using known methods. An example of such a method is described in WO2021/153545, that is, a method of reacting glycidyl methacrylate and gallic acid monohydrate in the presence of triethylamine.

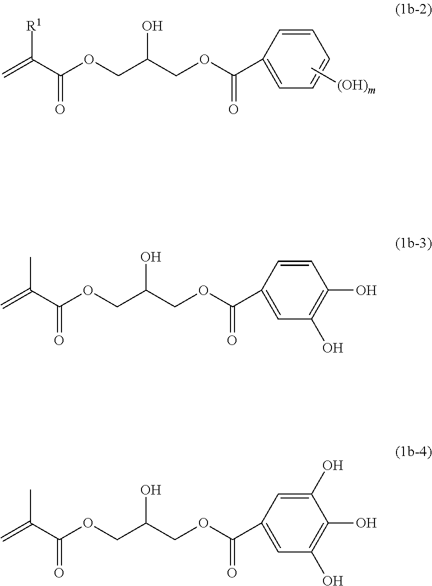

A preferable combination of monomers forming the constituent unit (1a) and the constituent unit (1b) in the molecular chain of the copolymer (P) used in the present invention is as follows.

### 2-Methacryloyloxyethyl (2-(trimethylammonio)ethyl) phosphate and Formula (1b-3)

### 2-Methacryloyloxyethyl (2-(trimethylammonio)ethyl) phosphate and Formula (1b-4)

[Ratio of Monomer (1a-1) to Monomer (1b-1)]

The molar ratio nₐ:n_{b} between the above-described constituent units represented by formulas (1a-1) and (1b-1) is 10 to 99:1 to 90, preferably 20 to 95:5 to 80, more preferably 30 to 90:10 to 70, and still more preferably 80 to 90:10 to 20. Here, nₐ is the number of moles of the constituent unit represented by the above-described formula (1a) in the copolymer (P), and n_{b} is the number of moles of the constituent unit represented by the above-described formula (1b) in the copolymer (P). By reducing nₐ or by increasing n_{b}, the adhesion force of the copolymer (P) to the surface of a soft contact lens can be increased. The stain resistance of the copolymer (P) can be increased by increasing nₐ. By reducing n_{b}, it is possible to make the copolymer (P) water-soluble, thereby facilitating the preparation of a treatment solution for soft contact lenses.

### [Other Monomers]

The copolymer (P) used in the present invention may include a constituent unit (1c) other than the constituent unit (1a) and the constituent unit (1b), as long as it does not impair the effect of the present invention.

The constituent unit (1c) can be arbitrarily selected from monomers (1c-1), which can be copolymerized with formula (1a-1) and/or formula (1b-1).

Examples of such monomers (1c-1) include the following: (meth)acrylates containing a hydroxy group such as 2-hydroxyethyl (meth)acrylate, 2-hydroxypropyl (meth)acrylate, 2-hydroxybutyl (meth)acrylate, 4-hydroxybutyl (meth)acrylate, glycerol (meth)acrylate, and 4-hydroxyphenyl (meth)acrylate; ion-containing monomers such as styrenesulfonic acid, (meth)acryloyloxyphosphonic acid, and 2-hydroxy-3-(meth)acryloyloxypropyltrimethylammonium chloride; nitrogen-containing monomers such as (meth)acrylamide, aminoethyl (meth)acrylate, N,N-dimethyl(meth)acrylamide, N,N-dimethylaminoethyl (meth)acrylate, N,N-dimethylaminopropyl (meth)acrylamide, N-acryloylmorpholine, 2-methacryloyloxyethyl phosphorylcholine, N-vinylpyrrolidone, N-vinylacetamide, and N-methyl-N-vinylacetamide;
(meth)acrylic acid esters such as (meth)acrylic acid methyl, (meth)acrylic acid ethyl, (meth)acrylic acid propyl, (meth)acrylic acid butyl, (meth)acrylic acid cyclohexyl, (meth)acrylic acid 2-ethylhexyl, (meth)acrylic acid n-octyl, (meth)acrylic acid isononyl, (meth)acrylic acid dodecyl, and (meth)acrylic acid stearyl; and
vinyl aryl monomer such as styrene, α-methylstyrene, vinyltoluene, indene, vinyl naphthalene, phenylmaleimide, and vinylaniline; alkenes such as ethylene, propylene, butadiene, isobutylene, and octane; carboxyl group-containing vinyls such as vinyl acetate and vinyl propionate; cyanovinyl-based monomers such as acrylonitrile and methacrylonitrile; polyethylene glycol (meth)acrylate; polypropylene glycol (meth)acrylate; and glycidyl (meth)acrylate.

These monomers may be used alone or in combination with two or more types. The proportion of monomer (1c-1) among all monomers used for the preparation of the copolymer of the present invention is preferably 0 to 30 mol %. This is because the effect of the present invention is preferably manifested.

### [Weight Average Molecular Weight of Copolymer (P)]

The weight average molecular weight of the copolymer (P) used in the present invention ranges from 10,000 to 2,000,000, preferably from 10,000 to 1,000,000, and more preferably from 200,000 to 300,000. By increasing the weight average molecular weight to more than 10,000, the adhesion force of the copolymer to soft contact lenses can be enhanced, thereby improving stain resistance. Conversely, by reducing the weight average molecular weight to less than 2,000,000, the copolymer becomes easier to handle.

The weight average molecular weight of the copolymer (P) is determined by gel permeation chromatography (GPC) measurement, calibrated against polyethylene glycol.

### [Production Method of Copolymer (P)]

The copolymer (P) can be produced by copolymerizing the monomers. The copolymer is usually a random copolymer, but it may also be an alternating copolymer or a block copolymer in which monomers are regularly arranged. Additionally, the copolymer may have a graft structure in part.

The above-described polymerization reaction can be performed in the presence of a radical polymerization initiator, under an inert gas atmosphere such as nitrogen, carbon dioxide, argon, or helium, by known a method such as bulk polymerization, suspension polymerization, emulsion polymerization, or solution polymerization. From the viewpoint of purification, solution polymerization is preferred. The purification of the polymer can be performed using a general purification method such as reprecipitation, dialysis, or ultrafiltration.

Examples of the radical polymerization initiator include azo-based radical polymerization initiators, organic peroxides, and persulfates.

Examples of the azo-based radical polymerization initiators include 2,2′-azobis(2-methylpropionamidine) dihydrochloride (V-50), 2,2′-azobis(2-diaminopropyl) dihydrochloride, 2,2′-azobis(2-(5-methyl-2-imidazolin-2-yl)propane) dihydrochloride, 4,4′-azobis(4-cyanovaleric acid), 2,2′-azobis(isobutyramide) dihydrate, 2,2′-azobis(2,4-dimethylvaleronitrile), and 2,2′-azobis(isobutyronitrile) (AIBN).

Examples of the organic peroxides include, for example, t-butylperoxyneodecanoate (Perbutyl (Registered Trademark) ND), benzoyl peroxide, diisopropylperoxydicarbonate, t-butylperoxy-2-ethylhexanoate, t-butylperoxypivalate, t-butylperoxyisobutyrate, lauroyl peroxide, and succinyl peroxide.

Examples of the persulfates include ammonium persulfate, potassium persulfate, and sodium persulfate.

These radical polymerization initiators can be used alone or in combination with two or more types. The amount of the polymerization initiator used is usually 0.001 to 10 parts by mass, preferably 0.01 to 5.0 parts by mass, based on 100 parts by mass of the monomer composition of the copolymer (P).

The polymerization reaction can be performed in the presence of a solvent, and as the solvent, a solvent that dissolves the monomer composition without reacting with the monomer composition can be used. Examples of the solvent include water; an alcohol-based solvent such as methanol, ethanol, n-propanol, and isopropanol; a ketone-based solvent such as acetone, methyl ethyl ketone, and diethyl ketone; an ester-based solvent such as ethyl acetate; a straight-chain or cyclic ether-based solvent such as ethyl cellosolve, tetrahydrofuran, and N-methylpyrrolidone; and a nitrogen-containing solvent such as acetonitrile and nitromethane. Preferably, water, an alcohol, or a mixed solvent thereof, more preferably a mixed solvent of water and an alcohol, is used.

### [Contact Lens Treatment Solution of the Present Invention]

The soft contact lens treatment solution of the present invention has a concentration of the copolymer (P) of 0.001% w/v or more, preferably 0.01% w/v or more, more preferably 0.1% w/v or more, and 5.0% w/v or less, preferably 2.0% w/v or less, more preferably 0.7% w/v or less. By setting the concentration of the copolymer (P) to 0.01% w/v or more, sufficient stain resistance can be obtained. Additionally, by keeping the concentration of the copolymer (P) at 5.0% w/v or less, a sasitfactory balance between the blending amount and stain resistance can be achieved.

In addition, “w/v %” in the present invention represents the mass of a certain component in grams (g) per 100 mL of solution. For example, “the treatment solution of the present invention contains 1.0 w/v % of the copolymer (P)” means that a 100 mL solution contains 1.0 g of the copolymer (P). As the solvent for use in the treatment solution of the present invention, water, ethanol, n-propanol, isopropanol, glycerol, propylene glycol, or a mixed solvent of these alcohols can be used.

Water used in the contact lens treatment solution of the present invention is typically water used in the manufacture of pharmaceuticals or medical devices. Specifically, ion-exchanged water, purified water, sterile purified water, distilled water, and water for injection can be used.

The soft contact lens treatment solution of the present invention can be formulated, in addition to a copolymer (P) and a solvent, by adding at least one component that is generally used in ophthalmic preparations from the following, as necessary: decongestant components, anti-inflammatory/astringent components, vitamins, amino acids, sulfonamides, sugars, cooling agents, inorganic salts, salts of organic acids, acids, bases, antioxidants, stabilizers, preservatives, mucin secretion promoters, and the like.

Examples of the decongestant component include epinephrine or salts thereof, ephedrine hydrochloride, tetrahydrozoline hydrochloride, naphazoline or salts thereof, phenylephrine, and methylephedrine hydrochloride.

Examples of the anti-inflammatory/astringent components include epsilon-aminocaproic acid, allantoin, berberine or salt thereof, sodium azulene sulfonate, glycyrrhizic acid or salts thereof, zinc lactate, zinc sulfate, and lysozyme chloride.

Examples of the vitamins include flavin adenine dinucleotide sodium, cyanocobalamin, retinol acetate, retinol palmitate, pyridoxine hydrochloride, panthenol, sodium pantothenate, and calcium pantothenate.

Examples of the amino acids include aspartic acid or salts thereof, and taurine.

Examples of the sulfonamides include sulfamethoxazole or salts thereof, sulfisoxazole, and sulfisomidine sodium.

Examples of the sugars include glucose, mannitol, sorbitol, xylitol, and trehalose.

Examples of the cooling agents include menthol and camphor.

Examples of the inorganic salts include sodium chloride, potassium chloride, borax, sodium bicarbonate, sodium dihydrogen phosphate, and anhydrous disodium hydrogen phosphate.

An example of the salts of organic acids is sodium citrate.

Examples of the acids include boric acid, phosphoric acid, citric acid, sulfuric acid, acetic acid, and hydrochloric acid.

Examples of the bases include sodium hydroxide, potassium hydroxide, tris(hydroxymethyl)aminomethane, and monoethanolamine.

Examples of the antioxidants include tocopheryl acetate, dibutylhydroxytoluene, and sodium bisulfite.

Examples of the stabilizers include sodium edetate, glycine, and taurine.

Examples of the preservatives include benzalkonium chloride, chlorhexidine gluconate, potassium sorbate, methylparaben, ethylparaben, propylparaben, isopropylparaben, butylparaben, isobutylparaben, and polyhexanide hydrochloride.

Examples of the mucin secretion promoters include diquafosol sodium and rebamipide.

In order to adjust the viscosity of the solution, a polymer other than the copolymer (P) may be blended into the treatment solution for the soft contact lens of the present invention.

Examples of such polymers include poly(meth)acrylic acid, (meth)acrylic acid-acryl(meth)acrylate copolymer, alginic acid, hyaluronic acid, chitosan, pullulan, hydroxyethyl cellulose, hydroxypropyl cellulose, hydroxypropylmethyl cellulose, carboxymethyl cellulose, polyvinylpyrrolidone, polyvinyl alcohol, and polyethylene glycol.

### EXAMPLES

The present invention will be described in detail based on Examples; however, the present invention is not limited to these Examples.

### <Measurement of Weight Average Molecular Weight>

An obtained copolymer (1 mg) was dissolved in a mobile phase (1 g) and measured. Other measurement conditions are as follows:
Column: SB-802.5HQ+SB-806MN HQ
Mobile phase: 20 mM phosphate buffer (pH 7.0)
Standard substance: polyethylene glycol/oxide
Measurement equipment: HLC-8320GPC (manufactured by Tosoh Corporation)
Calculation of weight average molecular weight: molecular weight calculation program (EcoSEC Data Analysis)
Flow rate: 0.5 mL/min
Injection amount: 100 L
Column oven: 45° C.
Measurement time: 70 minutes

### <Physiological Saline Solution Preparation>

Physiological saline was prepared with reference to the literature (ISO 18369-3:2017, Ophthalmic Optics-Contact Lenses Part 3: Measurement Methods). That is, 8.3 g of sodium chloride, 5.993 g of sodium hydrogen phosphate dodecahydrate, and 0.528 g of sodium dihydrogen phosphate dihydrate were weighed, dissolved in water to make a total volume of 1000 mL, and filtered to obtain physiological saline.

### <Measurement of Contact Angle>

The contact angle was measured using the droplet method, and the measurement apparatus used was DropMaster 500 from Kyowa Interface Science Co., Ltd. The liquid used for measuring the contact angle was ion-exchanged water, and the liquid droplet amount was 1 μL.

### Example 1-1

In Example 1-1, 16.1 g of 2-methacryloyloxyethyl (2-(trimethylammonio)ethyl phosphate (hereinafter referred to as “MPC”) (manufactured by NOF Corporation) and 3.0 g of the compound of formula (1b-4) were dissolved in 75.1 g of water and 32.2 g of ethanol. The resulting solution was placed into a 500 mL four-necked flask, and nitrogen was blown into the flask for 30 minutes. Subsequently, 0.19 g of Perbutyl (Registered Trademark) ND (PB-ND, manufactured by NOF Corporation) was added at 60° C., and the polymerization reaction was carried out for 8 hours. After the reaction was completed, the mixture was dialyzed and purified, followed by freeze-drying to obtain a white powder. The chemical structure of the obtained copolymer was confirmed by ¹H NMR.

¹H NMR data:
0.7-1.3 ppm (3H; CH₃—C—), 1.5-2.3 ppm (2H; —CH₂—C—), 3.2-3.4 ppm (9H; —N(CH₃)₃), 3.5-3.8, 4.1-4.5 ppm (4H; —OCH₂CH₂N—), 3.9-4.5 ppm (4H; —OCH₂CH₂O—), 3.9-4.8 ppm (5H; —CH₂CH(OH)CH₂—), 7.0-7.3 ppm (2H; Ar—H)

The molecular weight was confirmed by GPC, and the weight average molecular weight was 260,000.

### Example 1-2

In Example 1-2, 17.8 g of MPC and 1.0 g of a compound of formula (1b-4) were dissolved in 74.6 g of water and 32.0 g of ethanol. The resulting solution was placed in a 300 mL four-necked flask, and nitrogen was blown into the flask for 30 minutes. Subsequently, 0.19 g of PB-ND was added and the polymerization reaction was carried out at 60° C. for 8 hours. After the reaction was completed, the mixture was dialyzed and purified, followed by freeze-drying to obtain a white powder. The chemical structure of the obtained copolymer was confirmed by ¹H NMR.

¹H NMR data:
0.7-1.3 ppm (3H; CH₃—C—), 1.5-2.3 ppm (2H; —CH₂—C—), 3.2-3.4 ppm (9H; —N(CH₃)₃), 3.5-3.8, 4.1-4.5 ppm (4H; —OCH₂CH₂N—), 3.9-4.5 ppm (4H; —OCH₂CH₂O—), 3.9-4.8 ppm (5H; —CH₂CH(OH)CH₂—), 7.0-7.3 ppm (2H; Ar—H)

The molecular weight was confirmed by GPC, and the weight average molecular weight was 270,000.

### Example 1-3

In Example 1-3, 5.5 g of MPC and 2.5 g of the compound of formula (1b-4) were dissolved in 31.8 g of water and 13.6 g of ethanol. The resulting solution was placed in a 100 mL four-necked flask, and nitrogen was blown into the flask for 30 minutes. Subsequently, 0.08 g of PB-ND was added and the polymerization reaction was carried out at 60° C. for 8 hours. After the reaction was completed, the mixture was dialyzed and purified, followed by freeze-drying to obtain a white powder. The chemical structure of the obtained copolymer was confirmed by ¹H NMR.

¹H NMR data:
0.7-1.3 ppm (3H; CH₃—C—), 1.5-2.3 ppm (2H; —CH₂—C—), 3.2-3.4 ppm (9H; —N(CH₃)₃), 3.5-3.8, 4.1-4.5 ppm (4H; —OCH₂CH₂N—), 3.9-4.5 ppm (4H; —OCH₂CH₂O—), 3.9-4.8 ppm (5H; —CH₂CH(OH)CH₂—), 7.0-7.3 ppm (2H; Ar—H)

The molecular weight was confirmed by GPC, and the weight average molecular weight was 360,000.

### Comparative Example 1-1

In Comparative Example 1-1, 6.6 g of MPC, 4-hydroxyphenyl methacrylate (hereinafter referred to as “HPMA”, i.e., a compound in which R¹ is a methyl group, W¹ is O, L¹ has 0 carbon atoms, X¹ is a single bond, and m is 1 in formula (1b-1)), were dissolved in 14.9 g of water and 14.9 g of ethanol. The resulting solution was placed in a 100 mL four-necked flask, and nitrogen was blown into the flask for 30 minutes. Subsequently, 0.08 g of PB-ND was added and the polymerization reaction was carried out at 60° C. for 8 hours. After the reaction was completed, the mixture was dialyzed and purified, followed by freeze-drying to obtain a white powder. The chemical structure of the obtained copolymer was confirmed by IR and ¹H NMR.

¹H NMR data:
0.7-1.2 ppm (3H; CH₃—C—), 1.5-2.3 ppm (2H; —CH₂—C—), 3.2-3.4 ppm (9H; —N(CH₃)₃), 3.5-3.8, 4.1-4.5 ppm (4H; —OCH₂CH₂N—), 3.9-4.5 ppm (4H; —OCH₂CH₂O—), 3.9-4.8 ppm (5H; —CH₂CH(OH)CH₂—), 7.0-7.4 ppm (4H; Ar—H)

The molecular weight was confirmed by GPC, and the weight average molecular weight was 240,000.

### Comparative Example 1-2

In Comparative Example 1-2, 10.0 g of MPC was dissolved in 20.0 g of water and 20.0 g of ethanol. The resulting solution was placed in a 300 mL four-necked flask, and nitrogen was blown into the flask for 30 minutes. Subsequently, 0.1 g of PB-ND was added and the polymerization reaction was carried out at 60° C. for 8 hours. After the reaction was completed, the mixture was dialyzed and purified, followed by freeze-drying to obtain a white powder. The chemical structure of the obtained copolymer was confirmed by ¹H NMR.

¹H NMR data:
0.7-1.2 ppm (3H; CH₃—C—), 1.5-2.3 ppm (2H; —CH₂—C—), 3.2-3.4 ppm (9H; —N(CH₃)₃), 3.5-3.8 ppm, 4.1-4.5 ppm (4H; —OCH₂CH₂N—), 3.9-4.5 ppm (4H; —OCH₂CH₂O—)

The molecular weight was confirmed by GPC, and the weight average molecular weight was 250,000.

Table 1 and Table 2 indicate the materials used for the synthesis of the copolymers in Examples 1-1 to 1-3 and Comparative Examples 1-1 to 1-2, the charged amount thereof, the reaction conditions, the molar ratios of the obtained copolymer compositions (nₐ, n_{b}, n_{c}), and the weight average molecular weights.

TABLE 1

| | | Example | | | | | |
|---|---|---|---|---|---|---|---|
| | | 1-1 | | 1-2 | | 1-3 | |
| | | | Charged | | Charged | | Charged |
| | | Compound | amount (g) | Compound | amount (g) | Compound | amount (g) |
| Material | Monomer | MPC | 16.1 | MPC | 17.8 | MPC | 5.5 |
| | (1a-1) | | | | | | |
| | Monomer | Formula | 3.0 | Formula | 1.0 | Formula | 2.5 |
| | (1b-1) | (1b-4) | | (1b-4) | | (1b-4) | |
| | Monomer | — | — | — | — | — | — |
| | (1c-1) | | | | | | |
| | Solvent | Water | 75.1 | Water | 74.6 | Water | 31.8 |
| | | Ethanol | 32.2 | Ethanol | 32.0 | Ethanol | 13.6 |
| | Initiator | PB-ND | 0.19 | PB-ND | 0.19 | PB-ND | 0.08 |
| Reaction | Reaction | 60 | | 60 | | 60 | |
| condition | temperature | | | | | | |
| | (° C.) | | | | | | |

| | | | | |
|---|---|---|---|---|
| | Reaction time | 8 | 8 | 8 |
| | (hr) | | | |
| Molar | nₐ | 85 | 95 | 70 |
| ratio | n_{b} | 15 | 5 | 30 |
| | n_{c} | 0 | 0 | 0 |

| Weight average | 260,000 | 270,000 | 360,000 |
|---|---|---|---|
| molecular weight | | | |

TABLE 2

| | | Comparative Example | | | |
|---|---|---|---|---|---|
| | | 1-1 | | 1-2 | |
| | | Compound | Charged amount | Compound | Charged amount |
| | | | (g) | | (g) |
| Material | Monomer (1a-1) | MPC | 6.6 | MPC | 10.0 |
| | Monomer (1b-1) | — | — | — | — |
| | Monomer (1c-1) | HPMA | 1 | — | — |
| | Solvent | Water | 14.9 | Water | 20.00 |
| | | Ethanol | 14.9 | Ethanol | 20.00 |
| | Initiator | PB-ND | 0.08 | PB-ND | 0.10 |
| Reaction | Reaction | 60 | | 60 | |
| condition | temperature (° C.) | | | | |

| | | | |
|---|---|---|---|
| | Reaction time (hr) | 8 | 8 |
| Molar ratio | nₐ | 95 | 95 |
| | n_{b} | 5 | 5 |
| | n_{C} | 0 | 0 |

| Weight average molecular | 240,000 | 250,000 |
|---|---|---|
| weight | | |

### Example 2-1

In Example 2-1, 80 mL of physiological saline was measured, and 0.1 g of the copolymer obtained in Example 1-1 was weighed, added to the physiological saline, and dissolved. Subsequently, physiological saline was added to reach a total volume of 100 mL, sterilization filtration was performed, and the contact lens treatment solution indicated in Table 3 was prepared.

### Example 2-2 to 2-7

Except for using the types and amounts of components indicated in Table 3, contact lens treatment solutions were prepared following the same procedure as in Example 2-1.

### Comparative Examples 2-1 to 2-3

Except for using the types and amounts of components indicated in Table 4, contact lens treatment solutions were prepared following the same procedure as in Example 2-1.

Table 3 and Table 4 indicate the type of copolymer used in the preparation of the contact lens treatment solutions in Examples 2-1 to 2-7 and Comparative Examples 2-1 to 2-3, the formulation compositions of the copolimers, the concentrations of the copolymers, and the properties of the contact lens treatment solution.

TABLE 3

| | | Example | | | | | | |
|---|---|---|---|---|---|---|---|---|
| | | 2-1 | 2-2 | 2-3 | 2-4 | 2-5 | 2-6 | 2-7 |
| Used copolymer | | Example | Example | Example | Example | Example | Example | Example |
| | | 1-1 | 1-1 | 1-1 | 1-2 | 1-3 | 1-1 | 1-1 |
| Formulation | Copolymer (g) | 0.1 | 0.05 | 0.5 | 0.1 | 0.1 | 0.1 | 0.1 |
| composition | Glycerol (g) | 0 | 0 | 0 | 0 | 0 | 2.0 | 0 |
| | Propylene | 0 | 0 | 0 | 0 | 0 | 0 | 1.5 |
| | glycol (g) | | | | | | | |
| | Sodium edetate | 0 | 0 | 0 | 0 | 0 | 0.1 | 0.1 |
| | (g) | | | | | | | |
| | ISO | Set total | Set total | Set total | Set total | Set total | Set total | Set total |
| | Physiological | volume to | volume to | volume to | volume to | volume to | volume to | volume to |
| | saline | 100 mL | 100 mL | 100 mL | 100 mL | 100 mL | 100 mL | 100 mL |
| Concentration of | | 0.1 | 0.05 | 0.5 | 0.1 | 0.1 | 0.1 | 0.1 |
| copolymer (%) | | | | | | | | |
| Result | Property | Colorless | Colorless | Colorless | Colorless | Colorless | Colorless | Colorless |
| | | and | and | and | and | and | and | and |
| | | transparent | transparent | transparent | transparent | transparent | transparent | transparent |
| | | liquid | liquid | liquid | liquid | liquid | liquid | liquid |

TABLE 4

| | | Comparative Example | | |
|---|---|---|---|---|
| | | 2-1 | 2-2 | 2-3 |
| Used copolymer | | Comparative | Comparative | Absent |
| | | Example | Example | |
| | | 1-1 | 1-2 | |
| Formulation | Copolymer | 0.1 | 0.1 | 0 |
| composition | (g) | | | |
| | ISO Physio- | Set total | Set total | Set total |
| | logical | volume to | volume to | volume to |
| | saline | 100 mL | 100 mL | 100 mL |
| Concentration of copolymer (%) | | 0.1 | 0.1 | 0 |
| Result | Property | Colorless | Colorless | Colorless |
| | | and trans- | and trans- | and trans- |
| | | parent | parent | parent |
| | | liquid | liquid | liquid |

### Example 3-1

A commercially available contact lens (1-Day ACUVUE® OASYS®) was prepared. To a 15-mL conical tube, 10 mL of physiological saline was added, and a single contact lens taken out from a blister pack was immersed in the tube. The tube was then shaken for 6 hours. To a 10 mL glass vial, 5 mL of the contact lens treatment solution prepared in Example 2-1 was added, sealed, and sterilized at 121° C. for 20 minutes. The contact lens subjected to the above procedure was used as an evaluation lens. The evaluation lens was subjected to hydrophilicity evaluation, surface wettability evaluation, coating property evaluation, lipid adhesion inhibition evaluation, and durability evaluation according to the following procedures. Table 5 indicates the results.

### <Water Film Retention Evaluation Method>

The water film retention property of the contact lens was evaluated according to the following procedure.

The evaluation lens was taken out from the glass vial, and the time until the water film on the lens surface breaks (BUT) was measured with a stopwatch and evaluated according to the following criteria.

The longer the BUT time, that is, the lower the score, the better the water film retention property.
15 seconds or more: Score “0”
10 seconds or more, less than 15 seconds: Score “1”
5 seconds or more and less than 10 seconds: Score “2”
Less than 5 seconds: Score “3”

### <Surface Wettability Evaluation Method>

The surface wettability of the contact lens was evaluated according to the following procedure.

The evaluation lens was taken out of the glass vial, and the water on the surface of the lens was wiped off. The lens was placed on the measurement stage of the contact angle meter with the convex surface thereof facing upward, the contact angle was measured automatically, and the results were evaluated according to the following criteria.

The smaller the contact angle, that is, the lower the score, the better the surface wettability.
Less than 30°: Score “0”
30° or more, less than 45°: Score “1”
450 or more, less than 90°: Score “2”
900 or more: Score “3”

### <Coating Property Evaluation Method>

The coating property evaluation of the contact lens was performed according to the following procedure.

In 10 g of tocopherol, 0.05 g of Sudan Black B was dissolved, and 40 g of liquid paraffin was added and mixed uniformly. The resultant was used as the staining solution. The evaluation lens was taken out from the glass vial, the water on the surface of the lens was wiped off, and the lens was immersed in 1 mL of the staining solution for 5 minutes. The contact lens was taken out, and any excess staining solution was removed with physiological saline and a clean cloth moistened with physiological saline. The contact lens stained with the staining solution was immersed in 1.5 mL of physiological saline, and the absorbance at 600 nm was measured. The absorbance of the contact lens before staining will be referred to as A₀, and the absorbance of the contact lens after staining will be referred to as A₁.

According to the following equation (1), the increase in absorbance due to staining was calculated, scored based on the following determination criteria, and thus the coating property was evaluated.

Sudan Black B is hydrophobic and adsorbs to hydrophobic substances, so Sudan Black B is easily adsorbed onto a hydrophobic lens surface or hydrophobic spots. For this reason, a lower absorbance, that is, a lower score, indicates that the lens surface is coated with a hydrophilic polymer and that the coating property is excellent.

$$Absorbance = {A}_{1} - {A}_{0} \qquad Equation ( 1 )$$

Less than 0.5: Score “0”
0.5 or more, less than 1.0: Score “1”
1.0 or more, less than 2.0: Score “2”
2.0 or more: Score “3”

### <Lipid Adhesion Inhibition Evaluation Method>

The evaluation of lipid adhesion inhibition on the contact lens was conducted according to the following procedure. First, an artificial lipid was prepared using the method described below.

### Preparation of Artificial Lipid

First, 0.5 g of mixed lipids with the composition described below was mixed with 100 mL of a phosphoric acid/boric acid buffer solution described below. A suspension was then prepared from the mixture using a homogenizer at 60° C. The pH of the solution was adjusted to 7.0 using 1N hydrochloric acid.

Composition of Mixed Lipids

| | |
|---|---|
| Oleic acid: | 0.06 g |
| Linolenic acid | 0.06 g |
| Palmitic acid | 0.06 g |
| Tripalmitic acid | 0.81 g |
| Cetyl alcohol | 0.20 g |
| Myristyl myristate | 0.81 g |
| Cholesterol | 0.08 g |
| Cholesteryl palmitate | 0.08 g |
| Lecithin (egg-derived) | 2.83 g |

Composition of Phosphate-Borate Buffer Solution

| | |
|---|---|
| Sodium chloride | 2.25 g |
| Potassium dihydrogen phosphate | 1.25 g |
| Sodium tetraborate decahydrate | 5.65 |
| Ion exchange water | balance (the total volume to 250 mL) |

Next, the amount of lipid adhering to the contact lens was evaluated using the following procedure.

The evaluation lens was taken out from the glass vial, the water on the surface of the lens was wiped off, and the lens was immersed in 4 mL of the artificial lipid for 4 hours. The contact lens was lightly rinsed with physiological saline, the water was removed therefrom, and the lipid adhering to the lens was extracted by placing the lens in a sample tube containing 3 mL of an ethanol/diethyl ether solution (ethanol: diethyl ether=1:1 (volume %)). The solvent of the extraction liquid was evaporated, and the remaining lipid was quantified using the sulfuric acid-vanillin method (C_{S1}).

Further, the lipid in the untreated lens (Comparative Example 2-3 lens) was quantified using the same procedure as described above (C_{S0}).

The lipid adhesion inhibition rate was calculated according to the following equation (2), scored based on the following determination criteria, and thus the lipid adhesion inhibition effect was evaluated.

The higher the lipid adhesion inhibition rate, that is, the lower the score, the better the stain resistance.

$$Lipid adhesion inhibition rate ( \% ) = ( {C}_{S 0} - {C}_{S 1} ) / {C}_{S 0} \times 100 \qquad Equation ( 2 )$$

Lipid adhesion inhibition rate of 50% or more: Score “0”
Lipid adhesion inhibition rate of 25% or more to less than 50%: Score “1”
Lipid adhesion inhibition rate of less than 25%: Score “2”
   <Durability evaluation Method>

The durability evaluation was performed according to the following procedure.

The evaluation lens was taken out from the glass vial, immersed in 2 mL of physiological saline in a 24-well plate, and shaken for 3 hours (simulating wear). Subsequently, various tests were conducted.

### <Score Evaluation>

The scores of the various tests were totaled, and the difference between the scores before and after washing was evaluated. The smaller the score before washing and the smaller the difference in scores, the higher the performance in terms of imparting hydrophilicity and stain resistance, as well as the higher the durability.

### Examples 3-2 to 3-7

Except for using the types of contact lens treatment solution and contact lenses indicated in Table 5, the contact lenses were prepared and evaluated according to the same procedure as in Example 3-1.

### Comparative Examples 3-1 to 3-4

Except for using the types of contact lens treatment solution and contact lenses indicated in Table 6, the contact lenses were prepared and evaluated according to the same procedure as in Example 3-1.

Table 5 and Table 6 indicate the types of treatment contact lens treatment solutions and the types of contact lenses used, as well as the evaluations before and after cleaning.

TABLE 5

| | | Example | | | | | | |
|---|---|---|---|---|---|---|---|---|
| | | 3-1 | 3-2 | 3-3 | 3-4 | 3-5 | 3-6 | 3-7 |
| Used contact lens treatment | | Example | Example | Example | Example | Example | Example | Example |
| solution | | 2-1 | 2-2 | 2-3 | 2-4 | 2-5 | 2-6 | 2-7 |
| Used contact lens | | 1-Day | 1-Day | 1-Day | 1-Day | 1-Day | 1-Day | 1-Day |
| | | ACUVUE | ACUVUE | ACUVUE | ACUVUE | ACUVUE | ACUVUE | ACUVUE |
| | | OASYS | TruEye | OASYS | TruEye | OASYS | OASYS | TruEye |
| Evaluation | Hydrophilicity | 0 | 0 | 0 | 0 | 0 | 0 | 0 |
| result | evaluation score | (>15 s) | (>15 s) | (>15 s) | (>15 s) | (>15 s) | (>15 s) | (>15 s) |
| before | Surface | 0 | 1 | 0 | 0 | 0 | 0 | 0 |
| washing | wettability | (40°) | (45°) | (31°) | (35°) | (41°) | (39°) | (42°) |
| | evaluation score | | | | | | | |
| | Coating property | 0 | 1 | 0 | 1 | 0 | 0 | 0 |
| | evaluation score | (0.4) | (0.7) | (0.3) | (0.6) | (0.2) | (0.4) | (0.4) |
| | Lipid adhesion | 1 | 1 | 0 | 1 | 1 | 1 | 1 |
| | inhibition | (40%) | (36%) | (52%) | (41%) | (42%) | (42%) | (38%) |
| | evaluation score | | | | | | | |
| | Total score | 1 | 3 | 0 | 2 | 1 | 1 | 1 |
| Evaluation | Hydrophilicity | 0 | 0 | 0 | 0 | 0 | 0 | 0 |
| result after | evaluation score | (>15 s) | (>15 s) | (>15 s) | (>15 s) | (>15 s) | (>15 s) | (>15 s) |
| washing | Surface | 0 | 1 | 0 | 1 | 0 | 0 | 0 |
| (durability) | wettability | (41°) | (50°) | (32°) | (46°) | (41°) | (41°) | (43°) |
| | evaluation score | | | | | | | |
| | Coating property | 0 | 2 | 0 | 1 | 0 | 0 | 0 |
| | evaluation score | (0.4) | (1.1) | (0.4) | (0.9) | (0.3) | (0.4) | (0.4) |
| | Lipid adhesion | 1 | 1 | 0 | 1 | 1 | 1 | 1 |
| | inhibition | (35%) | (25%) | (50%) | (30%) | (40%) | (36%) | (35%) |
| | evaluation score | | | | | | | |
| | Total score | 1 | 4 | 0 | 3 | 1 | 1 | 1 |

| | | | | | | | |
|---|---|---|---|---|---|---|---|
| Difference between scores | 0 | 1 | 0 | 1 | 0 | 0 | 0 |
| before and after washing | | | | | | | |

TABLE 6

| | | Comparative Example | | | |
|---|---|---|---|---|---|
| | | 3-1 | 3-2 | 3-3 | 3-4 |
| Used contact lens treatment solution | | Comparative | Comparative | Comparative | Comparative |
| | | Example 2-1 | Example 2-2 | Example 2-3 | Example 2-3 |
| Used contact lens | | 1-Day | 1-Day | 1-Day | 1-Day |
| | | ACUVUE | ACUVUE | ACUVUE | ACUVUE |
| | | OASYS | TruEye | OASYS | TruEye |
| Evaluation | Hydrophilicity evaluation | 0 | 1 | 2 | 3 |
| result | score | (>15 s) | (11 s) | (7 s) | (3 s) |
| before | Surface wettability | 1 | 2 | 3 | 3 |
| washing | evaluation score | (44°) | (87°) | (98°) | (110°) |
| | Coating property evaluation | 2 | 3 | 3 | 3 |
| | score | (1.9) | (2.4) | (2.2) | (3.1) |
| | Lipid adhesion inhibition | 1 | 2 | 2 | 2 |
| | evaluation score | (26%) | (10%) | (0%) | (0%) |
| | Total score | 4 | 8 | 11 | 11 |
| Evaluation | Hydrophilicity evaluation | 1 | 2 | 2 | 3 |
| result | score | (11 s) | (6 s) | (6 s) | (3 s) |
| after | Surface wettability | 2 | 3 | 3 | 3 |
| washing | evaluation score | (88°) | (99°) | (101°) | (115°) |
| (durability) | Coating property evaluation | 3 | 3 | 3 | 3 |
| | score | (2.2) | (2.5) | (2.3) | (3.0) |
| | Lipid adhesion inhibition | 2 | 2 | 2 | 2 |
| | evaluation score | (5%) | (2%) | (0%) | (0%) |
| | Total score | 8 | 10 | 11 | 11 |

| | | | | |
|---|---|---|---|---|
| Difference between scores before | 4 | 2 | 0 | 0 |
| and after washing | | | | |

From the results of Examples 3-1 to 3-7 and Comparative Examples 3-1 to 3-4, it has been found that blending a copolymer (P) improves the hydrophilicity and stain resistance of soft contact lenses. Further, the effect improved depending on the blending concentration of the copolymer (P). Further, it has been found that the effect can be obtained even when the type of soft contact lens is changed.

This application is entitled to and claims the benefit of Japanese Patent Application No. 2022-056393 filed on Mar. 30, 2022, the disclosure of which including the specification and claims is incorporated herein by reference in its entirety.

### INDUSTRIAL APPLICABILITY

By using the copolymer of the present invention, it is possible to reduce discomfort caused by wearing contact lenses and to suppress adverse effects on the health of the wearer's eyes. Furthermore, these effects are also highly durable. Accordingly, the present invention is expected to contribute to the further popularization of contact lenses.

1. A copolymer (P) comprising:
constituent units represented by formulas (1a) and (1b) below: 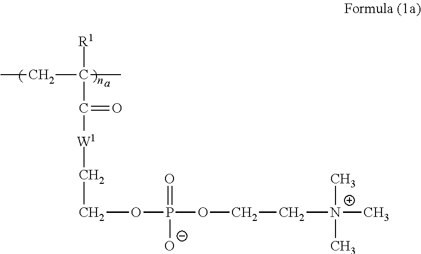
wherein, R¹ is a hydrogen atom or a methyl group, W¹ is O or NR², and R² is H or an alkyl group having 1 to 4 carbon atoms, and 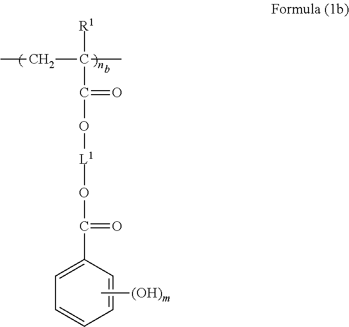
wherein, R¹ is a hydrogen atom or a methyl group, L¹ is an alkylene group having 1 to 5 carbon atoms or an alkylene group having 1 to 5 carbon atoms and including one or more hydroxy groups, and m is an integer of 2 or 3,
wherein
a molar ratio nₐ:n_{b} between the constituent units is 10 to 99:1 to 90, and
the copolymer (P) has a weight average molecular weight of 10,000 to 2,000,000.

2. A contact lens treatment solution comprising 0.001 to 5.0 w/v % of the copolymer (P) according to claim 1.
